(19) United States
(12) Patent Application Publication
(10) Pub. No.: US 2011/0011949 A1
(43) Pub. Date: Jan. 20, 2011

(54) Jimenez plant cube

(76) Inventor: Roberto Sulaica Jimenez, Jacksonville, FL (US)

Correspondence Address: Roberto S. Jimenez, 8300 Plaza Gate Lane # 1042, Jacksonville, FL, 32217, US

(21) Appl. No.: 12/460,062

(22) Filed: Jul. 14, 2009

(51) Int. Cl. B05B 15/00

(52) U.S. Cl. 239/76

(57) ABSTRACT

A wiring diagram that specifies basic electrical controls required to build a water dispensing system that controls the amount of water dispensed using a float control to determine the proper amount of water to be delivered to an installed irrigation system[s], and allows adjustment for water pressure requirements based on the size and capacity of the installed system[s] as well as the individual requirements of all water controls within the installed irrigation systems that have minimum water pressure requirements to activate, for the purpose of controlling the dispensing of water to various plants, or other yard features that require regular or daily watering.

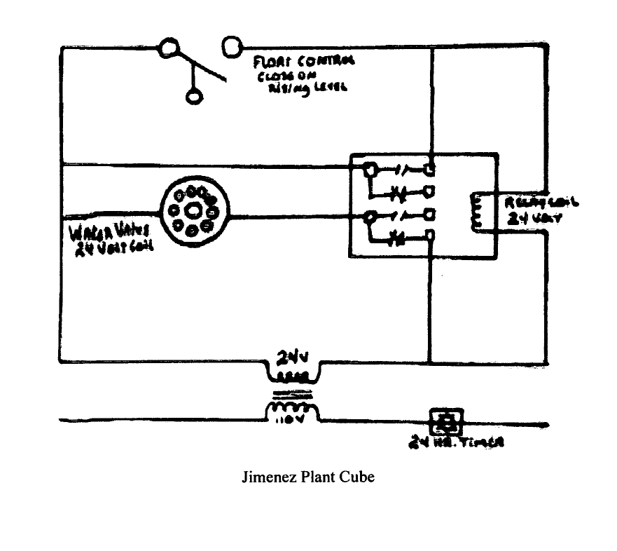

### CROSS REFERENCE TO RELATED APPLICATIONS

Not Applicable

### STATEMENT OF FEDERALLY FUNDED RESEARCH/DEVELOPMENT

Not Applicable

### REFERENCE TO A “SEQUENCE LISTING”

Not Applicable

### BACKGROUND OF INVENTION

Most current water dispensing irrigation devices use an electronic digital timer to “time” the watering for a particular area, this means that this type of electronic water dispensing system can water different areas for 1 hour in 8 to 12 different watering zones, however, this is saturation watering and does not address the “amount” of water required for that particular zone, in addition, electronic water dispensing systems do not address water pressure, which will vary, depending on the type of irrigation system installed and the exact amount of water and water pressure required to meet the needs of that individual irrigation system, or multiple irrigation systems.

Different types of irrigation systems require various water pressures to “energize” their control or water dispensing terminals, these types of spray heads include, spray misters, which may require at least 30 psi to bypass anti-drip features, another type of spray head is the “pop-up” lawn sprinkler, where the activation of these spray heads is dependent on minimum active water pressure to activate one or more of the spray heads on that line, if water pressure supplied is to too low, the lawn sprinkler heads will not “pop-up”, but instead, will leak water down the sides of the sprinkler.

### BRIEF SUMMARY OF INVENTION

The Jimenez Plant Cube [referring to the wiring diagram], uses a float control to address the amount of water dispensed, to insure that plants are not over watered by dispensing a set amount of water to plants each day that can be adjusted by regulating the supply pressure of the water coming from the sillcock—[city supply/usually 50 psi], or by balancing water pressures in more extensive irrigation systems that use multiple water dispensers [sprayheads].

To develop a water control system to improve the efficiency of current watering systems by addressing the amount of water required to meet the needs of an installed irrigation system and/or multiple irrigation systems requiring specific amounts of water and also addressing water pressures required to activate water controls within various irrigation systems for residential, commercial or agricultural applications.

The wiring diagram for the “Jimenez Plant Cube” was developed and designed by the inventor from the years 2001 to 2009, most of the mechanical components were mounted in remote locations, and the inventor used them to conduct field tests to determine if they could be modified to use in a single water control system.—Performance testing was also conducted to determine “run times”, and relative water pressures within an enclosed PVC Drip Irrigation System, some of these field tests were conducted using advanced prototype pvc watering systems.

### BRIEF SUMMARY OF INVENTION

Saturation points and minimum water pressures required to energize various water controls were also tested from the years 2001 to 2009, other types of controls that can be added are lawn sprinklers, pvc soaker hoses, oscillating sprinkler heads, pvc drip irrigation systems.

Provides automated watering for the following: Round Bushes and Long Hedges—Soaker Hose—Yard Borders—Oscillating Sprinkler Systems—Area Watering—Lawn Sprinklers—Pvc Drip Irrigation—Farm, Ranch and Agricultural Applications—An electrical wiring diagram for a water control system.

### BRIEF DESCRIPTION OF THE DRAWING

An overhead schematic view of an electrical wiring diagram showing all of the mechanical controls required to build [1] water control system.—The “electrical wiring diagram” is referred to by the inventor as the “Jimenez Plant Cube”.

### DETAILED DESCRIPTION

The “Jimenez plant cube”, is a wiring diagram for an independent stand-alone watering system that comprises five separate electrical controls installed in a weatherproof cabinet for outdoor use.—The manner in which the controls are wired in, and installed allow this system to accurately control not only the “run-times” of the daily water dispensing, but also, the amount of water dispensed by “balancing” the daily needs for several different types of irrigation systems.

The wiring diagram specifies five mechanical controls needed to build a single [1], water control system installed in a weatherproof cabinet for outdoor use.

The major components required are:—24 Volt Water Valve—24 Volt Transformer—¾ Inch PVC Float Control Valve—24 Hour Timer—Standard Lighting Timer—Double Pole/Double Throw Relay—24 Volt Coil—The weatherproof cabinet contains several standard and mechanical controls used to maintain regular watering of yard plants, hedges and/or trees.

1. I, [Roberto S. Jimenez] claim that the wiring diagram that is used in this water control system is the result of research and development in the field of water irrigation systems, conducted by the inventor from the years 2001 to 2009, and the wiring diagram is an original design that was created by the inventor to address water control and dispensing issues as regards to pvc irrigation systems, and I hereby state that I am the original author/inventor of this wiring diagram.
